(19) United States
(12) Patent Application Publication
(10) Pub. No.: US 2022/0358514 A1
(43) Pub. Date: Nov. 10, 2022

(54) SALES ATTEMPT TRACKING IN CUSTOMER RELATIONSHIP MANAGEMENT PLATFORM

(71) Applicant: State Farm Mutual Automobile Insurance Company, Bloomington, IL (US)

(72) Inventors: Michael Duff, Bloomington, IL (US); Venkata Siva Brahma Prakash Padigala, Bloomington, IL (US); Melissa Plassman, Bloomington, IL (US)

(21) Appl. No.: 17/734,925

(22) Filed: May 2, 2022

Related U.S. Application Data
(60) Provisional application No. 63/184,594, filed on May 5, 2021.

(51) Int. Cl. G06Q 30/00; G06F 16/28; G06Q 10/06; G06F 16/22; G06F 16/21

(52) U.S. Cl. CPC G06Q 30/01; G06F 16/289; G06Q 10/06375; G06F 16/2291; G06F 16/219

(57) ABSTRACT

A customer relationship management (CRM) platform may use a sales opportunity object to store information about a particular sales opportunity. However, if the life cycle of the sales opportunity involves multiple distinct sales attempts separated by dormant periods, the CRM platform can store historical data associated with one or more earlier sales attempts in sales attempt objects linked to the sales opportunity object. By storing historical data associated with previous sales attempts in linked sales attempt objects, the CRM platform can retain the historical data while allowing the sales opportunity object to be updated based on a more recent sales attempt.

### RELATED APPLICATIONS

This U.S. Patent Application claims priority to provisional U.S. Patent Application No. 63/184,594, entitled “SALES ATTEMPT TRACKING IN CUSTOMER RELATIONSHIP MANAGEMENT PLATFORM,” filed on May 5, 2021, the entirety of which is incorporated herein by reference.

### TECHNICAL FIELD

The present disclosure relates to customer relationship management (CRM) platforms, particularly with respect to tracking information about distinct sales attempts, associated with the same sales opportunity, that are separated by intervening dormancy periods.

### BACKGROUND

Businesses often use CRM platforms to track information about customers, including current customers, past customers, and prospective customers. For example, a CRM platform may track customer account data, sales information associated with sales of products or services to customers, historical contact information indicating when the business has contacted customers in the past, and/or other information associated with customers.

In particular, an agent of a business may use a CRM platform to track information about a sales opportunity associated with a customer. The CRM platform may use a single sales opportunity record, such as a data object, to track information related to successive stages, phases, or steps within an overall sales cycle associated with a sales opportunity. For example, the CRM platform may use the same sales opportunity record to track information about a sales opportunity during an information-gathering stage, and also to track information about the same sales opportunity during a later bid stage or quote stage.

However, in some situations, an agent may contact a customer multiple times over an extended period of time in association with the same sales opportunity before the customer agrees to purchase a product or service. The agent may, for example, contact the customer multiple times during the same stage of an overall sales cycle associated with the sales opportunity. As noted above, many existing CRM platforms are designed to use a single sales opportunity record to track information about a particular sales opportunity associated with a customer, even though it may take an agent multiple attempts at contacting the customer before the customer agrees to purchase a product or service. In some cases, a single sales opportunity record may be insufficient to capture or track information about multiple distinct sales attempts that have occurred with respect to one sales opportunity.

For example, an agent may initially contact a customer about potentially purchasing a product on February 1, but the customer may indicate that the time is not right for that purchase. The agent may wait for a period of time, and next attempt to contact the customer about the product on August 1. The customer's circumstances may have changed between February 1 and August 1, and the customer may agree to purchase the product on August 1. In this example, some existing CRM platforms may generate a sales opportunity record based on the initial February 1^{st} conversation between the agent and the customer, and then mark that sales opportunity record as closed after the August 1^{st} sale of the product to the customer. However, data indicating that the sales opportunity record was opened on February 1 and closed on August 1 may imply that the agent was in continuous contact with the customer about the sales opportunity every day for six months, even though in reality the agent only spoke with the customer on February 1 and August 1, and there was no contact, or was minimal contact, between the agent and the customer about the sales opportunity in the intervening six months.

Additionally, some existing CRM platforms may not provide sufficient fields to capture data in the same sales opportunity record about distinct sales attempts associated with the same sales opportunity. For instance, an agent may initially input data associated with a first sales attempt into a sales opportunity record. However, because sales opportunity records in many existing CRM platforms do not provide additional fields for additional sales attempts associated with the same sales opportunities, the agent may later need to delete information about the first sales attempt and replace that information with new information about a second sales attempt associated with the same sales opportunity. For example, if the agent provides a quote associated with a sales opportunity to a customer during a first sales attempt on February 1, the CRM platform may store the quote value in a sales opportunity record. If the agent then provides a new quote associated with the sales opportunity to the customer on August 1, because rates have changed in the interim, the customer's circumstances have changed, or for any other reason, the agent may need to delete the February 1 quote value from the sales opportunity record and replace it with the new August 1 quote value. Existing CRM platforms may not provide a mechanism to save older information about previous sales attempts associated with the same sales opportunity, such as the February 1 quote value discussed in this example. Accordingly, historical data about previous sales attempts may be lost in some existing CRM platforms when previously-created sales opportunity records are updated to reflect more recent sales attempts.

In some situations, agents may attempt to adjust for the issues discussed above, and to track individual sales attempts associated with the same sales opportunity, by opening distinct sales opportunity records for each sales attempt in existing CRM platforms. For instance, in the example above, an agent may open a first sales opportunity record to store information about the February 1 conversation with the customer, and open a separate second sales opportunity record to store information about the August 1 conversation with the customer. However, many existing CRM platforms do not provide a way to link separate sales opportunity records. Accordingly, in this example, the second sales opportunity record may be opened as a blank record. Due to the blank second sales opportunity record, the agent may not have the benefit of information about the February 1 conversation, stored in the separate first sales opportunity record, when the agent contacts the customer on August 1. The agent may have to ask the customer some of the same questions on August 1 that the agent already asked on February 1, in order to fill in the new blank sales opportunity record, which may be frustrating for the customer and/or the agent.

Alternatively, the agent may load the first sales opportunity record and use a user device to manually copy information from the first sales opportunity record into the new blank second sales opportunity record. However, manually copying data from one sales opportunity record into another can also be frustrating and/or time-consuming for the agent. Additionally, loading and using two distinct sales opportunity records can increase the amount of memory used by the CRM platform and/or the user device, increase a number of processor cycles used by the CRM platform and/or the user device, increase network bandwidth usage as data about the two distinct sales opportunity records are transmitted over networks between the CRM platform, the user device, or other network elements, and/or otherwise increase usage of computing resources.

Sales opportunity records that do not accurately reflect individual sales attempts associated with an overall sales opportunity, and do not indicate dormant periods between such individual sales attempts, may also negatively impact downstream analysis of the sales opportunity records. For example, the sales opportunity records kept by many existing CRM platforms do not track dormant periods between individual sales attempts, and may only indicate a date when the sales opportunity started and another date when the sales opportunity closed. If users try to get around this issue by creating separate distinct sales opportunity records for each individual sales attempt associated with the same sales opportunity, existing CRM platforms may not link those distinct sales opportunity records and it may be difficult to identify related sales opportunity records or to determine dormant periods between activities associated with the same sales opportunity. Accordingly, it may not be possible or feasible to use the records kept by many CRM platforms to determine an optimal period of time to wait between individual sales attempts associated with the same sales opportunity, or to determine how many distinct sales attempts have been performed during the life cycle of a particular sales opportunity.

The example systems and methods described herein may be directed toward mitigating or overcoming one or more of the deficiencies described above.

### SUMMARY

Described herein are systems and methods for retaining, in a CRM platform, historical information about multiple sales attempts that occur during the overall life cycle of a sales opportunity. For instance, the life cycle of the sales opportunity may involve multiple distinct sales attempts separated by dormant periods. The CRM platform may use a sales opportunity object to store information about the sales opportunity. However, the CRM platform may also create one or more sales attempt objects linked to the sales opportunity object. If the sales opportunity enters a dormant period and then re-enters an active period for a new sales attempt, the CRM platform can store data associated with the previous sales attempt in a sales attempt object. The CRM platform can then allow a user to edit the sales opportunity object based on the new sales attempt. If the sales opportunity again goes dormant for a period of time, and then becomes active again for another new sales attempt, the CRM platform can store data associated with the preceding sales attempt in another sales attempt object. Accordingly, by storing historical data associated with each previous sales attempt in linked sales attempt objects, the CRM platform can retain the historical data while allowing the sales opportunity object to be updated based on the most recent sales attempt.

According to a first aspect, a computer-implemented method can include generating, by one or more processors, and in memory associated with a CRM platform, a sales opportunity object associated with a sales opportunity. The method can also include generating, by the one or more processors, and in the memory, a sales attempt object linked to the sales opportunity object. The method can additionally include storing, by the one or more processors, first sales attempt data in the sales opportunity object, wherein the first sales attempt data corresponds with a first sales attempt associated with the sales opportunity. The method can also include changing, by the one or more processors, the sales opportunity object to a dormant stage. The method can further include determining, by the one or more processors, an activation of a sales attempt trigger associated with the sales opportunity object, based on receipt of a request to change the sales opportunity object from the dormant stage to an active stage, and the request being received at least a threshold period of time after the sales opportunity object was changed to the dormant stage. The method can also include populating, by the one or more processors, and in response to the activation of the sales attempt trigger, one or more fields of the sales attempt object based on the first sales attempt data stored in the sales opportunity object.

According to a second aspect, a computing device can include one or more processors and memory storing computer-executable instructions associated with a CRM platform that, when executed by the one or more processors, cause the one or more computing devices to perform operations. The operations can include generating, in the CRM platform, a sales opportunity object associated with a sales opportunity. The operations can additionally include generating, in the CRM platform, a sales attempt object. The sales attempt object can be linked to the sales opportunity object in the CRM platform. The operations can also include storing first sales attempt information associated with a first sales attempt, within a life cycle of the sales opportunity, in the sales opportunity object. The operations can further include changing the sales opportunity object from an active stage to a dormant stage, and changing the sales opportunity object from the dormant stage to the active stage or a second active stage, based on initiation of a second sales attempt within the life cycle of the sales opportunity. The operations can further include populating the sales attempt object based on the first sales attempt information stored in the sales opportunity object, and updating the sales opportunity object based on second sales attempt information associated with the second sales attempt.

According to a third aspect, a CRM platform can include memory storing a plurality of data objects, and a user interface. The plurality of data objects can include a plurality of sales opportunity objects associated with a plurality of sales opportunities, and a plurality of sales attempt objects associated with the plurality of sales opportunity objects. Individual sales opportunity objects, of the plurality of sales opportunity objects, can be associated with one or more related sales attempt objects, of the plurality of sales attempt objects. The plurality of sales attempt objects can be configured to store historical information associated with distinct historical sales attempts within life cycles of the plurality of sales opportunities. The user interface can be configured to display current information associated with a sales opportunity, based on a sales opportunity object of the plurality of sales opportunity objects. The user interface can also be configured to display historical information associated with one or more previous sales attempts, associated with the sales opportunity, based on one or more sales attempt objects of the plurality of sales attempt objects.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a system that can track information via a CRM platform, using a sales opportunity object and one or more sales attempt objects.

FIGS. 2A-2C show a first example in which the CRM platform modifies the sales opportunity object and associated sales attempt objects during the life cycle of a sales opportunity.

FIGS. 3A-3F show a second example in which the CRM platform modifies a sales opportunity object, and associated sales attempt objects, during the life cycle of a sales opportunity.

FIG. 4 shows a flowchart of an example process by which the CRM platform can store information associated with multiple sales attempts within a life cycle of a sales opportunity.

FIG. 5 shows an example system architecture for a computing device associated with the system.

### DETAILED DESCRIPTION

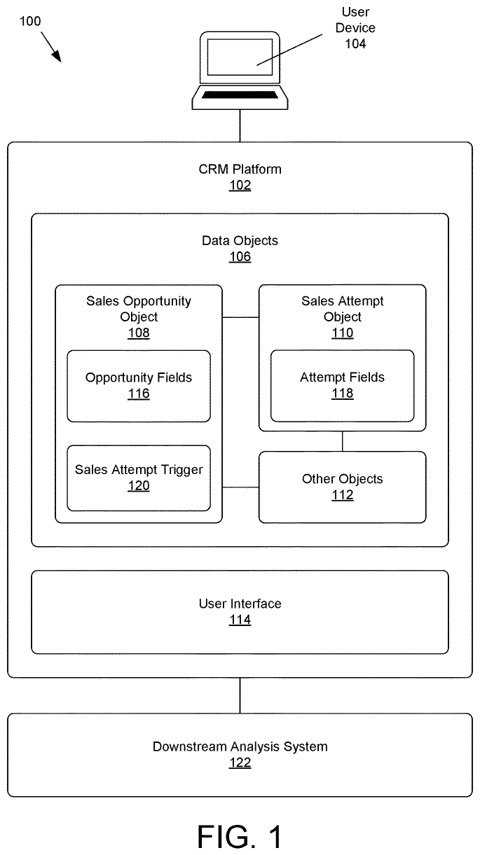

FIG. 1 shows an example of a system 100 that can track information via a CRM platform 102. A user can interact with the CRM platform 102 via a user device 104, for instance to view and/or edit information tracked by the CRM platform 102. The CRM platform 102 may store information in data objects 106, including a sales opportunity object 108 and at least one sales attempt object 110 linked to the sales opportunity object 108. The sales opportunity object 108 may be associated with a particular sales opportunity. One or more sales attempt objects, such as the sales attempt object 110 shown in FIG. 1, linked to the sales opportunity object 108 may be associated with distinct sales attempts associated with the particular sales opportunity. The data objects 106 may also include other objects 112 in addition to the sales opportunity object 108 and the one or more sales attempt objects, as discussed further below.

The CRM platform 102 may be a software application, a cloud-based application or service, or other type of platform that users can access via computing devices, such as the user device 104 shown in FIG. 1. The user device 104 can be a personal computer (PC), such as a laptop, desktop, or workstation, a smart phone, a tablet computer, a personal digital assistant (PDA), another type of mobile device, or any other type of computing or communication device. In some examples, CRM platform 102 can execute via one or more remote servers, and the user device 104 can access the CRM platform 102 via the Internet and/or other data networks. In other examples, the user device 104 may locally execute the CRM platform 102, or access the CRM platform 102 via a local network.

The CRM platform 102 may be configured to store information about customers of a business, including current customers, past customers, and prospective customers. The CRM platform 102 can be configured to store data in memory using data objects 106. Data objects 106 may be data objects, database records, or other types of digital records that have one or more fields, or other data storage elements, that can hold defined types of data. For example, the CRM platform 102 may use various types of data objects 106 to store, in memory, customer account data, sales information associated with sales of products or services to customers, historical contact information indicating when the business has contacted customers in the past, and/or other information associated with customers.

The CRM platform 102 may have a user interface (UI) 114 that can be displayed via the user device 104. The UI 114 of the CRM platform 102 may allow a user to view and/or edit data stored in one or more data objects 106. For example, the UI 114 may allow users to view information, search for information, edit information, input new information, and/or otherwise interact with information stored by the CRM platform 102.

The data objects 106 stored by the CRM platform 102 can include the sales opportunity object 108. The sales opportunity object 108 can be a record associated with a distinct sales opportunity associated with a customer. For example, the sales opportunity object 108 may represent a sales opportunity associated with a potential sale of a particular product or service to a particular customer.

The sales opportunity object 108 can include one or more opportunity fields 116 configured to store information about the sales opportunity. For example, the opportunity fields 116 can include fields configured to store a date when the sales opportunity object was created, an indication of a product or service associated with the sales opportunity, a date when the sale opportunity closed, a date when the sales opportunity was assigned to a sales representative, agent, or other user of the CRM platform 102, one or more types of notes that have been input by one or more users of the CRM platform 102, and/or other types of data associated with the sales opportunity.

The opportunity fields 116 of the sales opportunity object 108 can also include a stage field. The stage field can store a predefined value indicating a current stage of the sales opportunity. At any point in time, the sales opportunity may be in an active stage or a dormant stage, and the stage field of the sales opportunity object 108 have a value associated with the active stage or the dormant stage.

Active stages can include a “new” stage reflecting that the sales opportunity is new, or has been newly reopened and made active again after having been in a dormant stage. In some examples, other active stages can include an “assigned” stage indicating that the sales opportunity has been assigned to a particular user of the CRM platform 102, a “quoting” stage indicating that a sales quote for the product or service associated with the sales opportunity has been generated and/or provided to the customer, and/or other stages indicating that a user of the CRM platform 102 is actively working on the sales opportunity.

Dormant stages can include a “not now” or “not now—follow up” stage that indicates that the customer is not yet ready to purchase the product or service associated with the sales opportunity, but may be open to such a purchase in the future. A “not now” or “not now—follow up” stage can accordingly indicate that the sales opportunity is currently dormant, but that the user of the CRM platform 102 may follow up with the customer at a future time. Dormant stages may also include other stages in which a user of the CRM platform 102 is not actively working on the sales opportunity. For example, dormant stages may include a “closed sale” stage indicating that the customer has agreed to purchase the product or service, and thus that the sales opportunity is complete. Dormant stages may also include a “closed” or “closed—no contact” stage indicating that the customer has indicated they are not interested in the product or service at all, and that the user of the CRM platform 102 should not follow up with the customer unless the customer initiates subsequent contact about the product or service.

The sales opportunity object 108 can be linked to at least one sales attempt object, such as sales attempt object 110. Although the sales opportunity object 108 may represent a specific sales opportunity overall, in some cases the sales opportunity may involve one or more distinct sales attempts. For example, a user of the CRM platform 102 may attempt to contact a potential customer about a particular sales opportunity multiple times over weeks, months, or even years before the customer agrees to purchase a product or indicates that they are not interested in purchasing the product.

Accordingly, although the CRM platform 102 can use opportunity fields 116 of the sales opportunity object 108 to store data associated with the overall sales opportunity, the CRM platform 102 can also use distinct sales attempt objects to store and retain historical data about specific sales attempts associated with the overall sales opportunity. For example, the sales attempt object 110 can include one or more attempt fields 118 configured to store data associated with a particular sales attempt associated with the sales opportunity represented by sales opportunity object 108. At least some of the attempt fields 118 of the sales attempt object 110 may map to corresponding opportunity fields 116 of the sales opportunity object 108.

In some examples, the CRM platform 102 may initially create the sales attempt object 110 as a substantially empty shell record. For example, when the CRM platform 102 initially creates the sales attempt object 110 in memory, some attempt fields 118 of the sales attempt object 110 may store some types of initialization data, such as an object identifier, sales attempt number, sales attempt creation date, and/or other data. However, attempt fields 118 that map to corresponding opportunity fields 116 may be left empty, or be initialized with null values, during creation of the sales attempt object 110. The CRM platform 102 may initially create the sales attempt object 110 as a shell record at substantially the same time the CRM platform 102 creates the sales opportunity object 108. As will be discussed further below, data stored in the sales opportunity object 108 can, upon the sales opportunity object 108 returning to an active stage from an initial dormant stage, be transferred to the shell sales attempt object 110. The CRM platform 102 may also, in some examples, create one or more additional sales attempt objects, and transfer data stored in the sales opportunity object 108 to one or more additional sales attempt objects at one or more later times at which the sales opportunity object 108 returns from a dormant stage to an active stage. In alternate examples, the CRM platform 102 may not create a shell sales attempt object upon the initial creation of the sales opportunity object 108, and may instead wait to create a first sales attempt object once the sales opportunity object 108 returns to an active stage from a dormant stage.

The sales opportunity object 108 can have a sales attempt trigger 120, or the CRM platform 102 can associate the sales opportunity object 108 with the sales attempt trigger 120. The sales attempt trigger 120 can be associated with one or more defined conditions, such that the sales attempt trigger 120 activates if the one or more defined conditions are met. If the sales attempt trigger 120 is activated, the CRM platform 102 can fill in attempt fields 118 of a sales attempt object based on content of the sales opportunity object 108, such that data from the sales opportunity object 108 can be retained in the sales attempt object as discussed further below.

For example, the sales attempt trigger 120 can be configured to activate if the sales opportunity object 108 is changed from an active stage to a dormant stage, and is then changed back to an active stage after at least a threshold period of time. The threshold period of time can be a predefined period of time, such as a day, two days, a week, a month, or any other predefined period of time. As a non-limiting example, if the sales opportunity object 108 is changed from an active “new” stage to a dormant “not now” stage, and is then changed back to the active “new” stage after at least one day has passed since the sales opportunity object 108 was changed to the dormant “not now stage,” the CRM platform 102 can determine that the sales attempt trigger 120 has been activated. In these examples, if the stage of the sales opportunity object 108 is changed from one active stage to another active state, or from one dormant stage to another dormant stage, the conditions for activating the sales attempt trigger 120 may not be met. For example, the sales attempt trigger 120 may not activate if the stage of the sales opportunity object 108 changes from “not now” to “closed.”

In some examples, a user of the CRM platform 102 can provide user input that instructs the CRM platform 102 to change the sales opportunity object 108 from a current dormant stage to an active stage, and the CRM platform 102 can determine that the sales attempt trigger 120 has been activated based on the user input. For example, the user may have determined that, after a period in which the sales opportunity has been dormant, it is time to again actively engage in a new sales attempt associated with the sales opportunity, and can provide user input to change the sales opportunity object 108 from a “not now” stage to a “new” stage to re-open the sales opportunity. In some examples, the user may provide user input to edit a field of the sales opportunity object 108 while the sales opportunity object 108 is still in the dormant stage. In these examples, the CRM platform 102 may automatically change the stage of the sales opportunity object 108 from a dormant stage to an active stage, based on such express user input to edit another field in the sales opportunity object 108.

In other examples, the CRM platform 102 can determine that the sales attempt trigger 120 has been activated based on other types of input or instructions. For example, an agent of a business may have actively engaged in a first sales attempt with a customer, but placed the sales opportunity object 108 in a dormant “not now” stage because the customer indicated that he or she had no current interest in the sales opportunity. However, at a later point in time, the customer may indicate new interest in the sales opportunity without contact with the agent. For instance, the customer may have requested a new quote associated with the sales opportunity via a website of the business, or called a customer service phone number about the sales opportunity instead of calling the agent. In these examples, the CRM platform 102 may be configured to detect an indication of the customer's renewed interest in the sales opportunity, and may determine that the sales attempt trigger 120 has been activated. The CRM platform 102 may also automatically change the stage of the sales opportunity object 108 back to an active stage, and/or send a notification of the customer's renewed interest to the agent so that the agent can actively engage in a new sales attempt with the customer.

In some examples, the CRM platform 102 may be configured to automatically change the stage of the sales opportunity object 108, for instance during automatic or routine maintenance operations. In these examples, the sales attempt trigger 120 may be configured such that certain automatic changes of the stage of the sales opportunity object 108 do not activate the sales attempt trigger 120, and that the sales attempt trigger 120 can be activated based on express user input to change the stage of the sales opportunity object 108 from a dormant stage to an active stage, or based on certain express customer indications of interest in the sales opportunity.

If the sales attempt trigger 120 is activated, the CRM platform 102 can be configured to fill in attempt fields 118 of a previously created shell sales attempt object, or a new sales attempt object, based on content of the sales opportunity object 108, such that data from the sales opportunity object 108 associated with a previous sales attempt can be retained in the sales attempt object. In some examples, the CRM platform 102 may perform copy operations and/or move operations to transfer data from opportunity fields 116 of the sales opportunity object 108 to corresponding attempt fields 118 of the sales attempt object 110.

For example, the CRM platform 102 may be configured to perform copy operations to copy values of a first predefined set of opportunity fields 116 into corresponding attempt fields 118, while leaving those values intact in the first predefined set of opportunity fields 116. For example, the CRM platform 102 may be configured to copy values of certain opportunity fields 116 that are unlikely to change over time throughout the life cycle of the sales opportunity, or that are unlikely to change between sales attempts. Accordingly, the CRM platform 102 can copy such values to the sales attempt object 110, and the values can also remain stored in the sales opportunity object 108. For instance, data such as notes about the customer, indications of the product or service associated with the sales opportunity, and/or other data may be copied to the sales attempt object 110 and also be retained in the sales opportunity object 108 so that a user can access and/or edit that data via the UI 114 during the next sales attempt.

The CRM platform 102 may also be configured to perform move operations to move values of a second predefined set of opportunity fields 116 into corresponding attempt fields 118, and to clear those values from the second predefined set of opportunity fields 116. For example, the CRM platform 102 may be configured to move values of certain opportunity fields 116 that may be likely to change over time throughout the life cycle of the sales opportunity, or that are likely to change with respect to different sales attempts. Accordingly, the CRM platform 102 can move such values from opportunity fields 116 to the sales attempt object 110, so that the values can be retained in the sales attempt object 110. However, the CRM platform 102 can also nullify, delete, or clear the values from the opportunity fields 116 of the sales opportunity object 108. As such, the opportunity fields 116 can be cleared such that the opportunity fields 116 are available to be filled in again based on new user input associated with the next sales attempt. For instance, dates, quoted values, and/or other information that is specific to a particular sales attempt can be moved to a corresponding sales attempt object, and can then be deleted from the sales opportunity object 108. Accordingly, new dates, quoted values, or other information specific to the next sales attempt can be filled into corresponding cleared opportunity fields 116 of the sales opportunity object 108, while the cleared data remains stored in a sales attempt object linked to the sales opportunity object 108.

In some examples, if the sales attempt trigger 120 is activated, the CRM platform 102 may also derive values for attempt fields 118 of the sales attempt object 110, based on information associated with the sales opportunity object 108, the sales attempt object 110, and/or copy or move operations. For instance, the CRM platform 102 may derive a value for a dormancy period field in the sales attempt object 110, based on a number of days between a first date when the stage of the sales opportunity object 108 was changed to the dormant stage and a second date when instructions to change the stage of the sales opportunity object 108 back to an active stage were received.

By copying and/or moving data from the sales opportunity object 108 to the sales attempt object 110, and/or otherwise filling in attempt fields 118 of the sales attempt object 110, based on the activation of the sales attempt trigger 120, the CRM platform 102 can retain historical information about a previous sales attempt in the sales attempt object 110. The opportunity fields 116 of the sales opportunity object 108 can also be prepared to store new or changed data associated with a subsequent sales attempt. For example, if a user of the CRM platform 102 provides a customer with a first quote during a first sales attempt, and months later provides the customer with a second quote during a second sales attempt, the CRM platform 102 can retain information about the first quote in the sales attempt object 110, while allowing one or more opportunity fields 116 in the sales opportunity object 108 to be re-used to store new information about the second quote.

Overall, when the sales attempt trigger 120 is activated, the CRM platform 102 can be configured to move and/or copy data from the sales opportunity object 108 to an existing empty sales attempt object or a new sales attempt object. For example, when the sales opportunity object 108 is placed, after a first sales attempt, in a “not now” dormant stage for at least a threshold period of time, and is then changed to a “new” active stage for a second sales attempt, the sales attempt trigger 120 may be activated for a first time. Based on the first activation of the sales attempt trigger 120, the CRM platform 102 can fill in attempt fields of a previously-created shell sales attempt object 110 based on content of the sales opportunity object 108, including data associated with the first sales attempt.

If the sales opportunity object 108 is later placed in dormant stage for a second time, and is then again returned to an active stage for a third sales attempt after at least the threshold period of time, the sales attempt trigger 120 may be activated for a second time. Based on the second activation of the sales attempt trigger 120, the CRM platform 102 can create a new second sales attempt object linked to the sales opportunity object 108. The CRM platform 102 can accordingly store data, for instance associated with the second sales attempt, from the sales opportunity object 108 in the new second sales attempt object. Accordingly, any number of additional sales attempt objects can be linked to the sales opportunity object 108 over time as the sales opportunity object 108 changes back and forth between active stages and dormant stages and the sales attempt trigger 120 is activated.

The CRM platform 102 can link the sales opportunity object 108 with the sales attempt object 110 and/or other associated sales attempt objects. For example, the CRM platform 102 may have unique object identifiers for each data object. The CRM platform 102 can accordingly store an object identifier of the sales attempt object 110 in the sales opportunity object 108, and/or store an object identifier of the sales opportunity object 108 in the sales attempt object 110, to reflect the relationship between the sales opportunity object 108 and the sales attempt object 110. In other examples, the CRM platform 102 can store other types of information about relationships between two or more data objects 106, such as mapping tables, data objects or other data structures that store relationship information, and/or other types of relationship data.

The CRM platform 102 may similarly link the sales opportunity object 108, and/or one or more associated sales attempt objects, with one or more other objects 112. Other objects 112 may be data objects 106 that relate to other types of data, beyond sales opportunity and sales attempt information, that can be tracked by the CRM platform 102. For example, one or more other objects 112 may store data about users of the CRM platform 102, customer accounts, customer purchase histories, quotes provided to customers, and/or other types of data.

For example, if the sales opportunity object 108 represents a particular sales opportunity associated with a particular customer, the CRM platform 102 may link the sales opportunity object 108 to a data object representing a customer account associated with the particular customer, and/or link the sales opportunity object 108 to a data object associated with a user account associated with the user of the CRM platform 102. As another example, if the user of the CRM platform 102 provides a quote associated with the sales opportunity to the customer during a particular sales attempt, the CRM platform 102 may link the sales opportunity object 108 and/or a corresponding sales attempt object to a separate data object that stores information about the provided quote.

The CRM platform 102 may store different sales opportunity objects that correspond with different sales opportunities. For example, different sales opportunity objects may exist for different sales opportunities associated with different customers, and/or for different sales opportunities associated with potential sales of different products or services to the same customer. Each of these individual sales opportunity objects may be linked to one or more corresponding sales attempt objects, and/or other associated data objects 106.

In some examples, the CRM platform 102 can have, or be associated with, a downstream analysis system 122. The downstream analysis system 122 can be configured to use data stored in one or more data objects 106 to determine key performance indicators (KPIs), statistics, and/or other metrics associated with sales opportunities.

For example, the life cycle of a particular sales opportunity may involve active stages and/or dormant stages, as discussed above. Historical data associated with distinct sales attempts may be retained in sales attempt objects, while the sales opportunity object 108 may reflect current information about the sales opportunity. The sales opportunity object 108 and one or more corresponding sales attempt objects may individually and/or together indicate a total active duration associated with the sales opportunity overall, a total dormancy duration associated with the sales opportunity overall, durations of individual dormancy periods between active stages, how many individual sales attempts were performed during a life cycle of an overall sales opportunity, and/or other metrics. The downstream analysis system 122 may accordingly use the sales opportunity object 108 and one or more corresponding sales attempt objects to determine metrics associated with individual sales opportunities, average metrics or aggregated metrics associated with sets of sales opportunities, and/or other types of metrics.

In some examples, the downstream analysis system 122 may also use statistical analysis, machine learning, and/or other techniques to determine best practices for users of the CRM platform 102, based on sales opportunity objects, sales attempt objects, and/or other objects associated with one or more sales opportunities. For example, the downstream analysis system 122 can include one or more types of machine learning models, artificial intelligence models, or other predictive models based on convolutional neural networks, recurrent neural networks, other types of neural networks, nearest-neighbor algorithms, regression analysis, Gradient Boosted Machines (GBMs), Random Forest algorithms, deep learning algorithms, and/or other types of artificial intelligence or machine learning frameworks, which may be trained to use data objects 106 to predict or determine best practices for users of the CRM platform 102.

For instance, the downstream analysis system 122 may use historical information in data objects 106, including sales opportunity objects and sales attempt objects, to train a machine learning model to predict dormancy durations between active sales attempts that are most likely to lead to completed sales in different situations that may vary based on customer attributes, attributes of the product or service, time of the year, and/or any other attribute. As a non-limiting example, the machine learning model may determine from training data in previous sales opportunity objects and sales attempt objects that, in certain situations, customers are most likely to purchase a particular product during a second sales attempt associated with a sales opportunity if the second sales attempt occurs fourteen days after a first sales attempt associated with the sales opportunity.

In some examples, such predictions or determinations made by the downstream analysis system 122 may be provided to users of the CRM platform 102 via the UI 114, to the user device 104 via an email or another electronic notification, or in another type of report or output. As a non-limiting example, if the downstream analysis system 122 determines a predicted optimal dormancy period of fourteen days between sales attempts associated with a sales opportunity, the CRM platform 102 may recommend or schedule a follow-up sales attempt fourteen days after the stage of a sales opportunity object is changed from “new” to “not now—follow up.”

In some examples, the UI 114 can be configured to display information from the sales opportunity object 108, and/or related sales attempt objects, in a dashboard, table, chart, and/or other type of window, page, layout, or view. For example, during a third sales attempt within a life cycle of a sales opportunity, a user may load a page in the UI 114 associated with the sales opportunity object 108 that represents the sales opportunity. The sales opportunity object 108, as of the third sales attempt, may be associated with two sales attempt objects. The two sales attempt objects can include a first sales attempt object that has been filled in with data associated with a prior first sales attempt, and a second sales attempt object that has been filled in with data associated with a prior second sales attempt. The sales opportunity object 108 may have an attempt count field, or other data, indicating that there have been three sales attempts to date associated with the overall sales opportunity. The user may be able to view previous notes and other data that remains stored in the sales opportunity object 108, for use during the third sales attempt. The user can also provide new user input associated with the third sales attempt, and the CRM platform 102 can edit corresponding information in the sales opportunity object 108.

However, the UI 114 may also make information about the previous first and second sales attempts visible, based on the two sales attempt objects that are linked to the sales opportunity object 108. For instance, if a first quote was provided to the customer during the first sales attempt, information about that first quote can be retained in the first sales attempt object. The UI page associated with the sales opportunity object 108 may display current information stored in the sales opportunity object 108, as well as older information stored in one or more sales attempt objects. Accordingly, a user may be able to view or access information about the earlier first quote in the UI 114 based on information stored in the first sales attempt object, even if information about the first quote has been removed from the sales opportunity object 108 and/or the sales opportunity object 108 has been updated to contain newer information about a more recent quote provided to the customer. The user can thus access information about current and previous quotes in the same page or layout in the UI 114. Similarly, the user can use the UI 114 to access any other information about previous sales attempts, stored in one or more sales attempt objects, while working on a new sales attempt in association with the sales opportunity object 108.

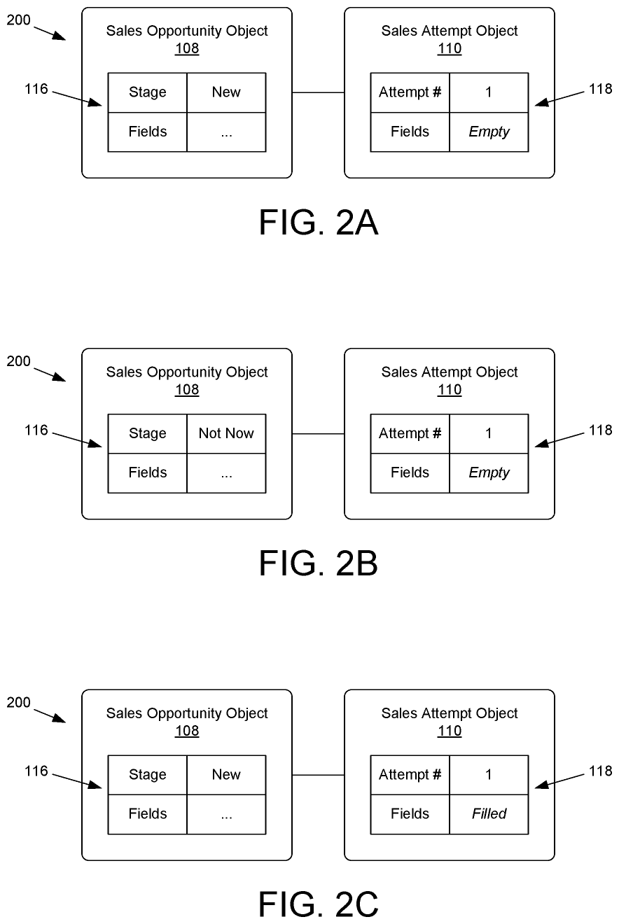

FIGS. 2A-2C show a first example 200 in which the CRM platform 102 modifies the sales opportunity object 108 and at least one sales attempt object during the life cycle of a sales opportunity. As shown in FIG. 2A, the CRM platform 102 can create the sales opportunity object 108 in memory, for example based on user input associated with a new sales opportunity. The opportunity fields 116 of the sales opportunity object 108 can include a stage field that initially indicates that the sales opportunity object 108 is in the “new” stage, or another active stage.

The CRM platform 102 can also create the corresponding sales attempt object 110 in memory, and can link the sales opportunity object 108 with the sales attempt object 110. The sales attempt object 110 can have attempt fields 118, including an attempt number field that the CRM platform 102 initializes with a value of “1” to indicate that the sales attempt object 110 is associated with a first sales attempt of the overall sales opportunity.

In some examples, the value of the attempt number field can be a text string value that expresses a numeral using one or more alphanumeric characters. The CRM platform 102 may be configured to number data objects with sequential integer values for all users and/or all sales opportunities. However, using text strings instead of automatically provided object numbers can allow the value of the attempt number field to reflect number of the current sales attempt with respect to the particular sales opportunity represented by the sales opportunity object 108. In other examples, the value of the attempt number field can be an integer value initialized to 1, or be expressed using any other data type.

The CRM platform 102 may also copy the value of the attempt number field from the sales attempt object 110 to a sales attempt count field of the sales opportunity object 108. Accordingly, the sales opportunity object 108 can also include information indicating that, at the point shown in FIG. 2A, the sales opportunity is currently associated with a first sales attempt.

In some examples, the CRM platform 102 may initialize one or more other attempt fields 118 of the sales attempt object 110, such as by adding a date and/or time that the sales attempt object 110 was created. However, the CRM platform 102 may substantially create the sales attempt object 110 as a shell record, such that some or all of the other attempt fields 118 are left empty. In some examples, the CRM platform 102 may add a flag or other value indicating that, at the point shown in FIG. 2A, the sales attempt object 110 is currently a shell record.

After the CRM platform 102 creates the sales opportunity object 108 and the sales attempt object 110 in memory as shown in FIG. 2A, a user of the CRM platform 102 may engage in the first sales attempt with the customer. For example, the user may attempt to contact the customer to offer a product or service to the customer. The user can provide any user input associated with the first sales attempt to the CRM platform 102, which can store such data in the opportunity fields 116 of the sales opportunity object 108. For example, the user can provide user input to the CRM platform 102, such as notes about completed or attempted communications with the customer, dates and/or times of such communications, information about a quote provided to the customer, and/or any other information about the first sales attempt, and the CRM platform 102 may store the user input in opportunity fields 116 of the sales opportunity object 108.

However, the customer may not respond to the user's attempt to contact the customer, or may indicate to the user that the customer is not currently interested in the product or service. In these or other situations, the user may choose to follow up with the customer at a later date. The user can provide user input to the CRM platform 102 that causes the stage of the sales opportunity object 108 to be changed from an active stage to a dormant stage, such as the “not now” stage, as shown in FIG. 2B. At the point shown in FIG. 2B, data about the sales opportunity, and the first sales attempt associated with the sales opportunity, remains stored in the opportunity fields 116 of the sales opportunity object 108, and is not yet stored in the shell sales attempt object 110.

After the sales opportunity object 108 has been in a dormant stage for a period of time, the user can engage in a second sales attempt associated with the sales opportunity. The user may accordingly provide user input that instructs the CRM platform 102 to change the stage of the sales opportunity object 108 from the current dormant stage to an active stage. For example, the user input may be an instruction to change the stage of the sales opportunity object 108 from “not now” to “new.” In other examples, the customer may initiate the second sales attempt by contacting the user of the CRM platform 102 directly, or by indicating interest in the sales opportunity via a website, email, phone call to a call center, or in any other way that prompts the CRM platform 102 notify the user of the CRM platform 102 that the sales opportunity has again become active.

The CRM platform 102 may determine that the sales attempt trigger 120 has been activated, based on the stage of the sales opportunity object 108 having been in the dormant stage for at least a threshold period of time before being returned to an active stage. Accordingly, upon activation of the sales attempt trigger 120, the CRM platform 102 may copy and/or move data stored in the opportunity fields 116 of the sales opportunity object 108 to corresponding attempt fields 118 of the sales attempt object 110, and/or otherwise fill in the sales attempt object 110 with data associated with the first sales attempt and/or a dormancy period between the first sales attempt and the second sales attempt.

Accordingly, if the sales attempt trigger 120 is activated based on instructions to change the stage of the sales opportunity object 108 from a dormant stage (as shown in FIG. 2B) to an active stage, the CRM platform 102 can fill in values of attempt fields 118 of the sales attempt object 110 based on the sales opportunity object 108, as shown in FIG. 2C. Because the sales opportunity object 108 contained data associated with the first sales attempt, data associated specifically with the first sales attempt can be stored and retained in the sales attempt object 110 that corresponds to the first sales attempt. The CRM platform 102 can therefore retain historical information about the first sales attempt in the sales attempt object 110, while preparing the sales opportunity object 108 to be re-used to store data relevant to the new second sales attempt. The CRM platform 102 can also change the stage of the sales opportunity object 108 to “new” or another active stage, based on the instructions that activated the trigger.

The CRM platform 102 may also determine that a sales attempt count field of the sales opportunity object 108 had a value of “1,” and/or that the attempt number field of the sales attempt object 110 has a value of “1,” and accordingly increment the value of the sales attempt count field of the sales opportunity object 108 to a value of “2.” Accordingly, the sales opportunity object 108 can also be updated to indicate that two sales attempts have been associated with the sales opportunity to date.

After the CRM platform 102 fills in the sales attempt object 110 with information based on data previously stored in the sales opportunity object 108, as shown in FIG. 2C, a user of the CRM platform 102 may engage in the second sales attempt with the customer. The user may provide input about the second sales attempt to the CRM platform 102, which the CRM platform 102 can store in the sales opportunity object 108. If the second sales attempt results in a successful sale, the stage of the sales opportunity object 108 may be changed to a “closed sale” dormant stage, or other dormant stage.

However, if the second sales attempt is not successful, a user may provide instructions to change the stage of the sales opportunity object 108 back to the “not now” stage, or another dormant stage. If later, after another dormancy period, the CRM platform 102 receives instructions to change the sales opportunity object 108 back from the dormant stage to an active stage, the sales attempt trigger 120 can again be activated. Upon such activation of the sales attempt trigger 120, the CRM platform 102 can create a second sales attempt object in memory, and copy and/or move data associated with the second sales attempt from the sales opportunity object 108 into the second sales attempt object. Accordingly, the CRM platform 102 can retain historical information about the second sales attempt in the second sales attempt object, and prepare the sales opportunity object 108 to be re-used to store data relevant to a new third sales attempt.

Overall, each time the sales attempt trigger 120 associated with the sales opportunity object 108 is activated based on instructions to change the sales opportunity object 108 from a dormant stage to an active stage, the CRM platform 102 can copy and/or move data relevant to a previous sales attempt from the sales opportunity object 108 into a previously created shell sales attempt object or a new sales attempt object. This process can allow the CRM platform 102 to retain historical information about one or more previous sales attempts in corresponding sales attempt objects, while also allowing the CRM platform 102 to re-use the sales opportunity object 108 to store data about the most recent sales attempt. Accordingly, the CRM platform 102 can avoid losing data associated with previous sales attempts, and/or can avoid creating multiple sales opportunity objects associated with the same overall sales opportunity that may have duplicated data.

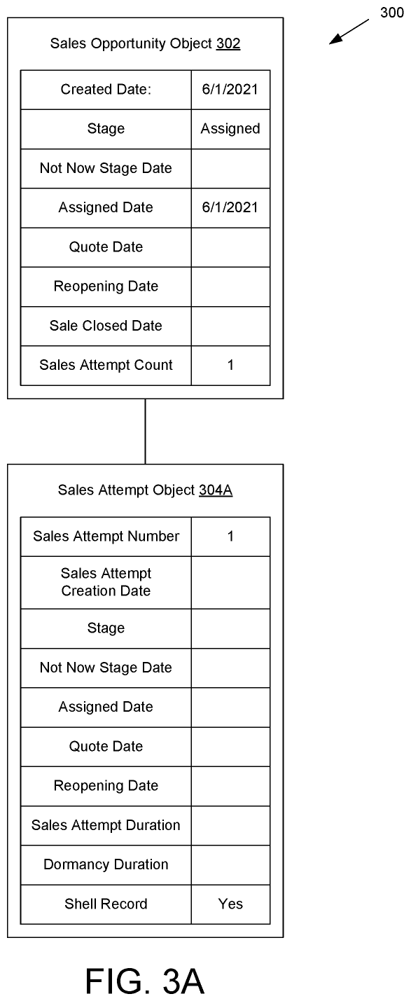

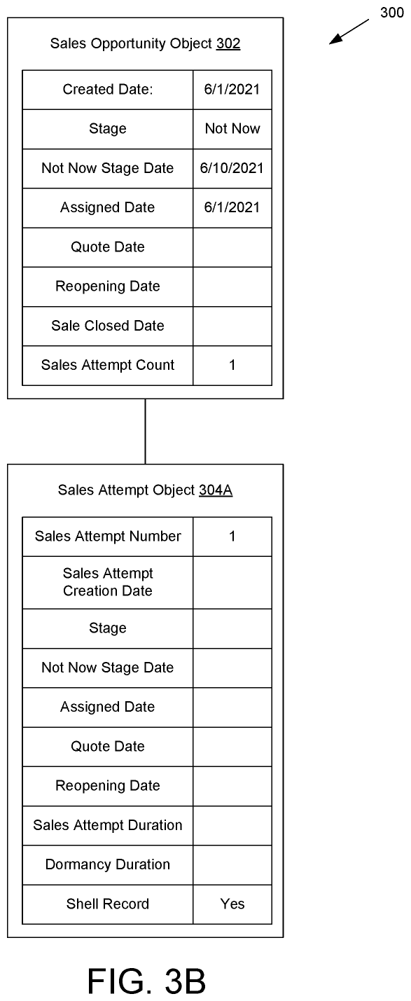

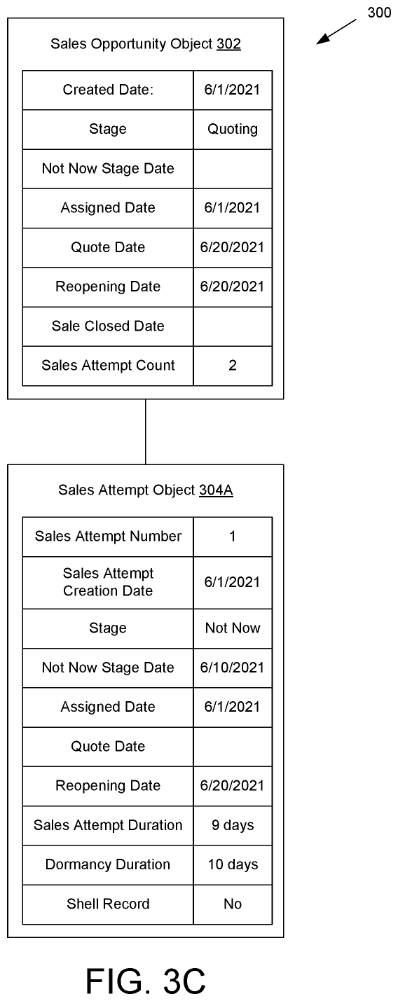

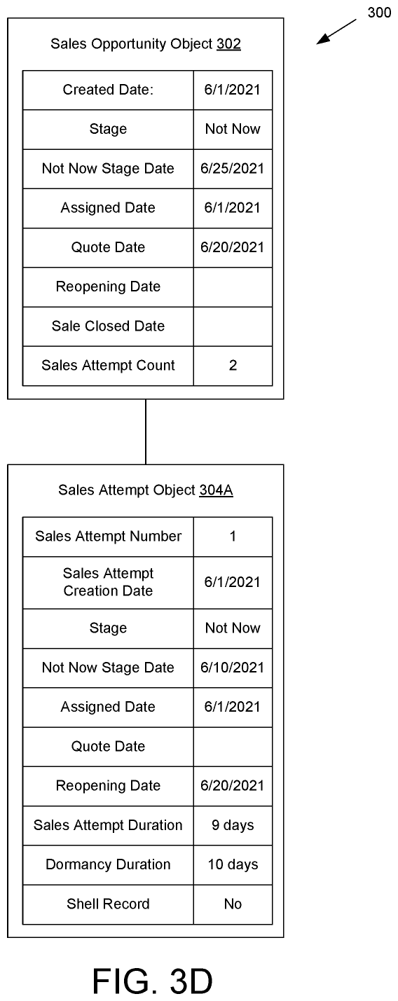

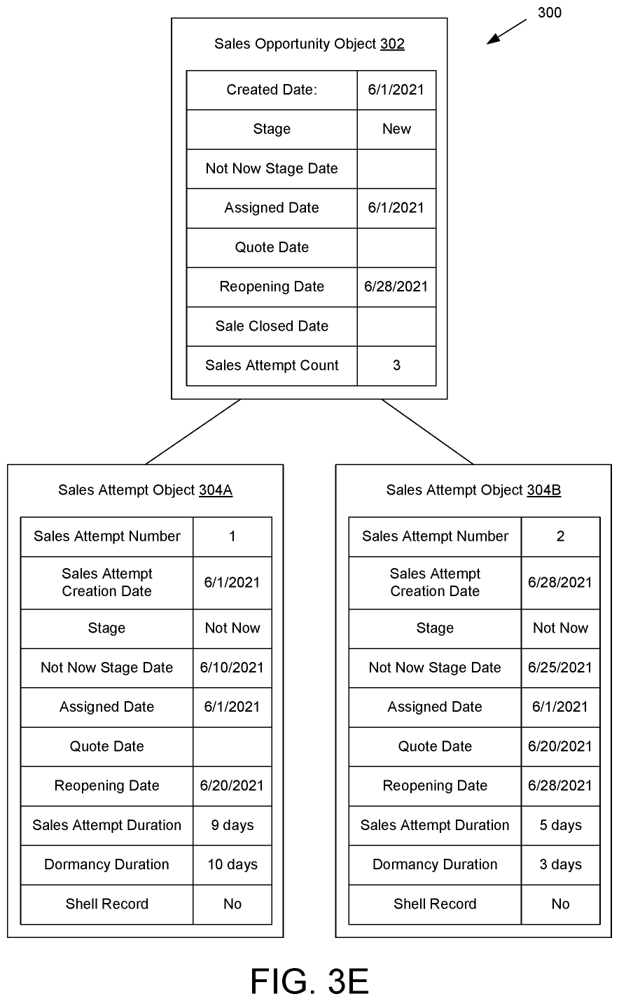

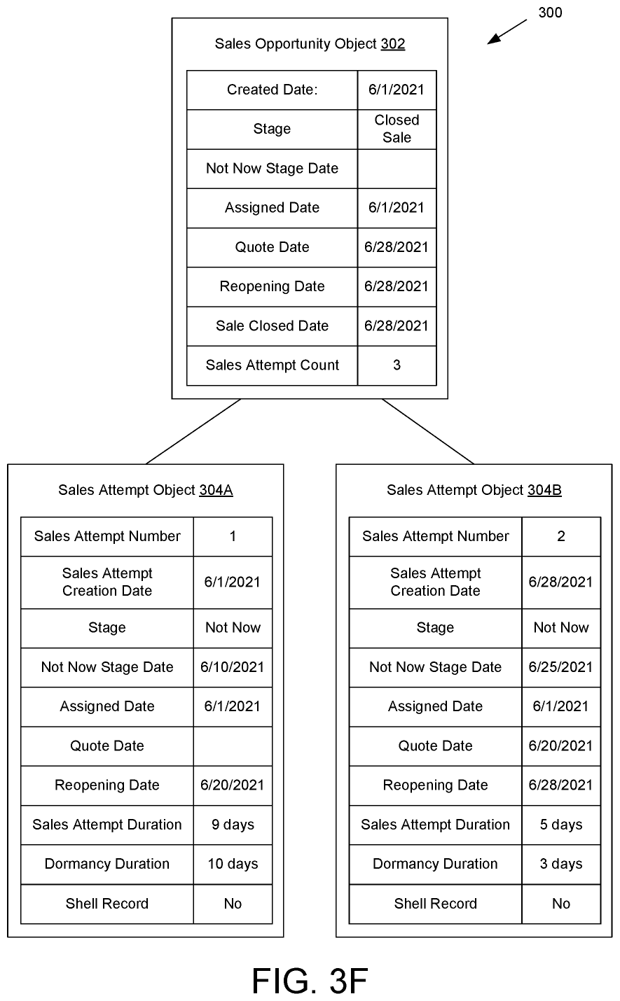

FIGS. 3A-3F show a second example 300 in which the CRM platform 102 modifies a sales opportunity object 302, and associated sales attempt objects, during the life cycle of a sales opportunity. The second example 300 may be a non-limiting example associated with a sales opportunity, in which an insurance agent may make multiple attempts at selling an insurance policy to a potential customer over a period of time, for instance by providing different insurance quotes for the insurance policy to the customer at different times.

FIG. 3A shows the state of example 300 as of Jun. 1, 2021. On Jun. 1, 2021, the CRM platform 102 can create the sales opportunity object 302 in memory, for example based on user input associated with the new sales opportunity. The CRM platform 102 may populate a “created date” field of the sales opportunity object 302 to indicate that the sales opportunity object 302 was created on Jun. 1, 2021. The CRM platform 102 may also populate a “stage” field of the sales opportunity object 108 with a value of an active stage. For instance, if user input indicates that the sales opportunity has been assigned to a particular insurance agent, such as the user of the CRM platform 102, the CRM platform 102 may populate the “stage” field with a value of “assigned,” and fill in Jun. 1, 2021 as a value for a corresponding “assigned date” field. Alternatively, the CRM platform 102 may populate the “stage” field with a value of “new,” or a value for another type of active stage.

The CRM platform 102 may also create a first sales attempt object 304A in memory, and link the first sales attempt object 304A to the sales opportunity object 302. The CRM platform 102 may populate a “sales attempt number” field of the first sales attempt object 304A with a value of “1,” and also fill in a corresponding “sales attempt count” field of the sales opportunity object 302 with a value of “1.” In some examples, the CRM platform 102 may also populate a “sales attempt creation date” field of the first sales attempt object 304A with the Jun. 1, 2021 date. In other examples, the CRM platform 102 may leave the “sales attempt creation date” field empty, to be filled in later. The CRM platform 102 may also leave other fields of the first sales attempt object 304A empty, and may in some examples add a flag or other value indicating that the first sales attempt object 304A is currently a shell record.

FIG. 3B shows the state of example 300 as of Jun. 10, 2021. In example 300, a user of the CRM platform 102 may actively attempt to contact the customer about the sales opportunity between Jun. 1, 2021 and Jun. 10, 2021 as part of a first sales attempt. However, on Jun. 10, 2021, the user may determine that the sales opportunity should be put on hold for a period of time until the next sales attempt. For instance, the customer may have informed the user that they may be open to purchasing an insurance policy in the future, but are not yet ready to do so.

Accordingly, the user may provide user input on Jun. 10, 2021 that causes the CRM platform 102 to change the stage of the sales opportunity object 302 to the “not now” dormant stage, as shown in FIG. 3B. The CRM platform 102 may also fill in Jun. 10, 2021 as a value for the “not now stage date” field of the sales opportunity object 302. The customer may not yet have been open to receiving a quote for the insurance policy, and as such a “quote date” field and/or other quote-related fields may still be empty in the sales opportunity object 302, as shown in FIG. 3B. Additionally, as of Jun. 10, 2021, when the sales opportunity object 302 is changed from the “assigned” active stage to the “not now” dormant stage, the first sales attempt object 304A can remain a shell record.

FIG. 3C shows the state of example 300 as of June 20. Although the sales opportunity may be dormant between Jun. 10, 2021 and Jun. 20, 2021, the sales opportunity may again become active on Jun. 20, 2021 due to a user's choice to actively re-engage in the sales opportunity, or based on an indication that the customer has expressed new interest in the sales opportunity. The CRM platform 102 may determine that the sales attempt trigger 120 associated with the sales opportunity object 120 has been activated, based on the indication that the sales opportunity will be in an active stage again after being in the “not now” dormant stage.

In response to the activation of the sales attempt trigger 120, the CRM platform 102 can fill in some or all fields of the first sales attempt object 304A based on data stored in the sales opportunity object 302. As noted above, the CRM platform 102 may be configured to associate some fields of the sales opportunity object 302 with copy operations, and associate other fields of the sales opportunity object 302 with move operations.

For example, the CRM platform 102 may be configured to copy the value shown in FIG. 3B from the “assigned date” field of the sales opportunity object 302 into the corresponding “assigned date” field of the first sales attempt object 304A as shown in FIG. 3C. By performing a copy operation, the date that the sales opportunity was assigned to an agent can be stored in both the sales opportunity object 302 and the first sales attempt object 304A, as shown in FIG. 3C. Accordingly, the “assigned date” value can be visible to a user who accesses data associated with the sales opportunity object 302.

As another example, if the “sales attempt creation date” of the first sales attempt object 304A was not previously filled in, the CRM platform 102 may fill in the “sales attempt creation date” of the first sales attempt object 304A. For example, the CRM platform 102 may fill in the “sales attempt creation date” of the first sales attempt object 304A based on the creation date of the sales opportunity object 302, because the first sales attempt object 304A was created (as a shell record) at the same time as the sales opportunity object 302.

As yet another example, the CRM platform 102 may be configured to move values shown in FIG. 3B from the “stage” field, the “not now stage date” field, and the “quote date” field of the sales opportunity object 302 into the corresponding “stage” field, the “not now stage field,” and the “quote date” field of the first sales attempt object 304A, as shown in FIG. 3C. Accordingly, such values can be retained in the first sales attempt object 304A, but can be cleared from the sales opportunity object 302. As such, a user may be able to fill in new values for those fields in the sales opportunity object 302 with respect to the second sales attempt, while older values for those fields that were associated with the first sales attempt can be maintained in the first sales attempt object 304A. In this example, because no quote had been provided to the customer before the sales opportunity was placed in the dormant “not now” stage on Jun. 10, 2021, the “quote date” field of the first sales attempt object 304A can remain empty because the corresponding “quote date” field of the sales opportunity object 302 had previously been empty as shown in FIG. 3B.

Based on activation of the sales attempt trigger 120 on Jun. 20, 2021, the CRM platform 102 can also derive information to fill in other fields of the first sale attempt object 304A. For example, the CRM platform 102 can indicate in a “reopening date” field of the first sale attempt object 304A that the sales opportunity was reopened on Jun. 20, 2021. The CRM platform 102 may also determine that the first sales attempt had been active for nine days between Jun. 1, 2021 and Jun. 10, 2021 based on a difference between the “sales attempt creation date” and the “not now stage date,” and that the sales opportunity was dormant for ten days between Jun. 10, 2021 and Jun. 20, 2021 based on a difference between the “not now stage date” and the “reopening date.” Accordingly, the CRM platform 102 can add a value of “9 days” in a “sales attempt duration” field of the first sale attempt object 304A, and can add a value of “10 days” in a “dormancy duration” field of the first sale attempt object 304A.

The CRM platform 102 may also, based on activation of the sales attempt trigger 120, change a field, flag or other value to indicate that the first sales attempt object 304A is no longer a shell record. The CRM platform 102 may also determine that the “sales attempt count” field of the sales opportunity object 302 had a value of “1,” and increment the “sales attempt count” field of the sales opportunity object 302 to a value of “2.”

As shown in FIG. 3C, after the CRM platform 102 has filled in the first sales attempt object 304A with data associated with the first sales attempt, data stored in the sales opportunity object 302 can be updated to reflect information associated with the second sales attempt. For instance, if the user provides the customer with a quote during the second sales attempt on Jun. 20, 2021, the CRM platform 102 can change the “stage” field to an active “quoting” stage, fill in Jun. 20, 2021 as a value for the “quote date” field, and/or fill in Jun. 20, 2021 as a value for the “reopening date” field. In addition, other information previously stored in the sales opportunity object 302, that was not cleared based on a move operation to move data to the first sales attempt object 304A, can remain in the sales opportunity object 302 such that the data is visible and/or editable via the UI 114 in association with the sales opportunity object 302.

FIG. 3D shows the state of example 300 as of Jun. 25, 2021. The user of the CRM platform 102 may have actively attempted to contact the customer about the sales opportunity between Jun. 20, 2021 and Jun. 25, 2021, as part of the second sales attempt. However, on Jun. 25, 2021, the user may determine that the sales opportunity should be put on hold for a period of time until the next sales attempt. For instance, the customer may have informed the user that they may be open to purchasing an insurance policy in the future, but are not yet ready to do so.

Accordingly, the user may provide new user input on Jun. 25, 2021 that causes the CRM platform 102 to change the stage of the sales opportunity object 302 back to the “not now” dormant stage, as shown in FIG. 3D. The CRM platform 102 may also fill in Jun. 25, 2021 as a value for the “not now stage date” field of the sales opportunity object 302. Because a quote was provided to the customer on Jun. 20, 2021 in association with the second sales attempt, associated data can remain reflected in the “quote date” field and/or other fields of the sales opportunity object 302.

FIG. 3E and FIG. 3F show different states of example 300 on Jun. 28, 2021. Although the sales opportunity may be dormant between Jun. 25, 2021 and Jun. 28, 2021, the sales opportunity may again become active on Jun. 28, 2021. The CRM platform 102 may determine that the sales attempt trigger 120 associated with the sales opportunity object 302 has been activated for a second time, based on an indication that the sales opportunity will be in an active stage again after being in the “not now” dormant stage.

Based on the second activation of the sales attempt trigger 120, the CRM platform 102 can create a second sales attempt object 304B, as shown in FIG. 3E, and link the second sales attempt object 304B to the sales opportunity object 302. The CRM platform 102 may fill in the “sales attempt creation date” field of the second sales attempt object 304B based on the current date of Jun. 25, 2021. The CRM platform 102 can also fill in some or all fields of the second sales attempt object 304B based on data stored in the sales opportunity object 302, as shown in FIG. 3E.

For example, the CRM platform 102 can copy the “sales attempt count” of “2” from the from the sales opportunity object 302 to the “sales attempt number” field of the second sales attempt object 304B, move the “not now” stage value and the “not now stage date” from the sales opportunity object 302 to corresponding fields of the second sales attempt object 304B, copy the “assigned date” from the sales opportunity object 302 to the second sales attempt object 304B, move the “quote date” from the sales opportunity object 302 to the second sales attempt object 304B, indicate a reopening date of Jun. 28, 2021 in fields of both the sales opportunity object 302 and the second sales attempt object 304B, store a value of “5 days” in the “sales attempt duration” field of the second sales attempt object 304B based on the second sales attempt being active between Jun. 20, 2021 and Jun. 25, 2021, and store a value of “3 days” in the “dormancy duration” field of the second sales attempt object 304B based on the sales opportunity being dormant between Jun. 25, 2021 and Jun. 28, 2021.

After move operations have been performed, the CRM platform 102 can also clear fields of the sales opportunity object 302 associated with the move operations. For example, values of the “not now stage date” and “quote date” fields can be cleared from the sales opportunity object 302 after those values have been moved to the second sales attempt object 304B, as shown in FIG. 3E. The CRM platform 102 can also update a “reopening date” field of the sales opportunity object 302 to indicate that the sales opportunity has been reopened as of Jun. 28, 2021, and can similarly change the “stage” of the sales opportunity object 302 from the previous “not now” dormant stage to the “new” active stage as shown in FIG. 3E.

As shown in FIG. 3F, after the CRM platform 102 has filled in the second sales attempt object 304B with data associated with the second sales attempt, data stored in the sales opportunity object 302 can be updated to reflect information associated with the third sales attempt. For instance, although the quote provided to the customer on Jun. 20, 2021 during the second sales attempt may have expired, the user may provide the customer with a new quote on Jun. 28, 2021. The CRM platform 102 may accordingly update the “quote date” field, and/or other associated fields, of the sales opportunity object 302 to indicate that a new quote was provided on Jun. 28, 2021, as shown in FIG. 3F. Information about the June 20 quote can be retained in the second sales attempt object 304B, as discussed above. If the customer also accepts the June 28 quote on June 28, such that the sale is completed, the CRM platform 102 can also update the stage of the sales opportunity object 302 to the “closed sale” dormant stage, and fill in Jun. 28, 2021 as a value for the “sale closed date” field of the sales opportunity object 302, as shown in FIG. 3F.

By retaining historical information about previous sales attempts in sales attempt objects, such as the first sales attempt object 304A and the second sales attempt object 304B, the sales opportunity object 302 can be used to store information about the overall sales opportunity and/or the most recent sales attempt. Accordingly, although data associated with the overall sales opportunity may change over time during multiple different sales attempts, historical data about prior sales attempts can be stored and retained in sales attempt objects even if the sales opportunity object 302 is updated based on later sales attempts.

Additionally, the sales opportunity object and/or the corresponding sales attempt objects can be used to determine KPIs or other metrics associated with the sales opportunity. For example, the downstream analysis system 122 or another element of the CRM platform 102 can determine, based on aggregating information in the first sales attempt object 304A and the second sales attempt object 304B, that the sales opportunity was associated with a total sales attempt duration of 14 days and a total dormancy duration of 13 days. Accordingly, although the sales opportunity object 302 itself only indicates that the sales opportunity object 302 was created on Jun. 1, 2021 and that the sale was closed on Jun. 28, 2021, the sales attempt objects can provide more granular information indicating that the 27 intervening days included 13 active days and 14 dormant days.

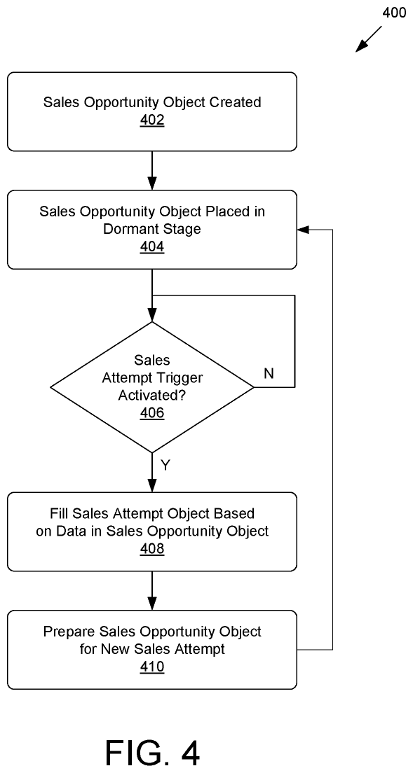

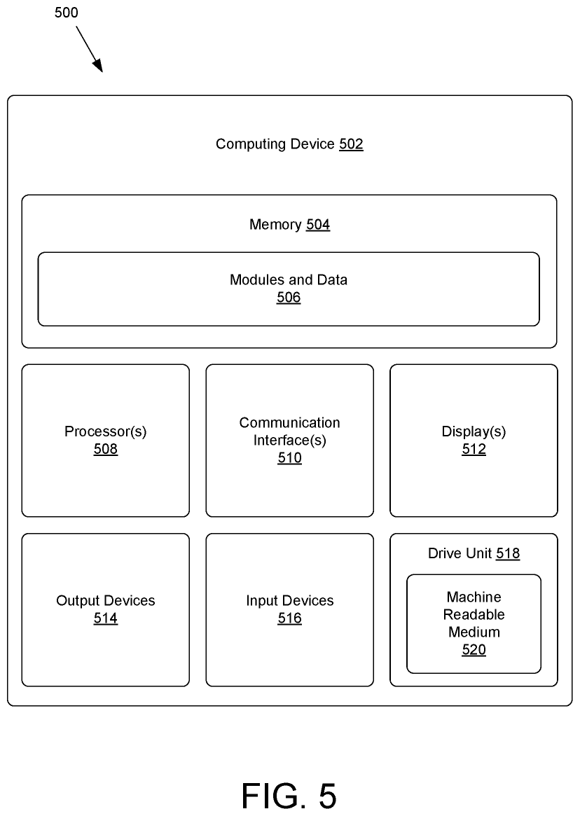

FIG. 4 shows a flowchart of an example process 400 by which the CRM platform 102 can store information associated with multiple sales attempts within a life cycle of a sales opportunity. Process 400 may be implemented using one or more computing devices. An example system architecture for such a computing device is described below with respect to FIG. 5.

At block 402, the CRM platform 102 can create a sales opportunity object associated with the sale opportunity in memory. The sales opportunity object can have opportunity fields configured to store data associated with the sales opportunity, based on user input received via the UI 114. The UI 114 can also be configured to display information from any or all of the opportunity fields. In some examples, at block 402, the CRM platform 102 can also create a first sales attempt object in memory, and link the first sales attempt object to the sales opportunity object. The CRM platform 102 may create the first sales attempt object substantially as a shell record at block 402.

After block 402, the CRM platform 102 may receive user input associated with an active sales attempt, and can edit opportunity fields of the sales opportunity object based on the user input. However, at block 404, the CRM platform 102 may place the sales opportunity object in a dormant stage. For example, user input may indicate that a user of the CRM platform 102 no longer intends to actively work on the sales opportunity, or plans to keep the sales opportunity dormant for a period of time before later re-attempting the sales opportunity. Accordingly, at block 404, the CRM platform 102 may change a stage of the sales opportunity object to a “not now” stage, or other dormant stage.

After the stage of the sales opportunity object has been placed in the dormant stage at block 404, the CRM platform 102 can wait until the sales attempt trigger 120 associated with the sales opportunity object is activated at block 406. For example, at block 406 the CRM platform 102 can determine whether one or more conditions associated with the sales attempt trigger 120 have been met. For instance, the sales attempt trigger 120 may be configured to activate if the sales opportunity object is changed from a dormant stage to an active stage after at least a day, or any other threshold period of time, has passed since the sales opportunity object was placed in the dormant stage. For example, if a user provides user input to change the sales opportunity object to the dormant stage, but then instructs the CRM platform 102 to change the sales opportunity object back to the active stage a few minutes later, the conditions for the sales attempt trigger 120 may not be met. In this situation, the relatively quick change back to the active stage may indicate a continuation of the previous sales attempt. However, if such instructions are received more than a day later, or after any other threshold period of time associated with the sales attempt trigger 120, the CRM platform 102 can determine that the sales attempt trigger 120 has been activated and that a new sales attempt associated with the overall sales opportunity has begun.

At block 408, after the CRM platform 102 has determined at block 408 that the sales attempt trigger 120 has been activated, the CRM platform 102 can fill in fields of a sales attempt object based on content of the sales opportunity object. For example, if the sales attempt trigger 120 has been activated for a first time, and the CRM platform 102 created a first sales attempt object as a shell record at block 402, the CRM platform 102 can fill in data of the first sales attempt object based on the sales opportunity object at block 408. If the sales attempt trigger 120 has been activated for at least the second time, at block 408 the CRM platform 102 can create a new sales attempt object, link the new sales attempt object to the sales opportunity object, and fill in fields of the new sales attempt object based on content of the sales opportunity object. In alternate examples, the CRM platform 102 may be configured to not create a shell record at block 402, and may create and fill a new sales attempt record at block 408 based on a first activation of the sales attempt trigger 120 and/or any subsequent activation of the sales attempt trigger 120. At block 408, the CRM platform 102 can use copy and/or move operations to fill in fields of a sales attempt object, and/or can derive values for fields of the sales attempt object, as discussed above.

At block 410, the CRM platform 102 can also prepare the sales opportunity object for a new sales attempt. For example, any data that is transferred to the sales attempt object via a move operation at block 408 can be cleared from the sales opportunity object, such that corresponding fields of the sales opportunity object can be cleared to receive new values associated with the new sales attempt.

If the sales opportunity object is again placed in a dormant stage at block 404, and is again changed back to an active stage such that the CRM platform 102 determines that the sales attempt trigger 120 is activated at block 406 again, the CRM platform 102 can repeat block 408 and block 410 to create a new sales attempt object, store data associated with the preceding sales attempt in the newly created sales attempt object, and prepare the sales opportunity object to receive data associated with a new sales attempt.

FIG. 5 shows an example system architecture 500 for a computing device 502 associated with the system 100 described herein. The computing device 502 can be a server, computer, or other type of computing device that executes at least a portion of the system 100, such as one or more elements of the CRM platform 102, the user device 104, or the downstream analysis system 122. In some examples, elements of the system 100 can be distributed among, and/or be executed by, multiple computing devices. For instance, elements of the CRM platform 102 can be executed by one or more computing devices, while the downstream analysis system 122 can be executed by one or more other computing devices. The user device 104 can be another computing device.

The computing device 502 can include memory 504. In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 502. Any such non-transitory computer-readable media may be part of the computing device 502.

The memory 504 can store modules and data 506. In some examples, the modules and data 506 can include data associated with the CRM platform 102, such as sales opportunity objects, sales attempt objects, and/or other objects. The modules and data 506 can also include any other modules and/or data that can be utilized by the computing device 502 to perform or enable performing any other actions. Such other modules and data can include a platform, operating system, and applications, and data utilized by the platform, operating system, and applications.

The computing device 502 can also have processor(s) 508, communication interfaces 510, displays 512, output devices 514, input devices 516, and/or a drive unit 518 including a machine readable medium 520.

In various examples, the processor(s) 508 can be a central processing unit (CPU), a graphics processing unit (GPU), both a CPU and a GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing computer applications stored in the memory 504, which can be associated with common types of volatile (RAM) and/or nonvolatile (ROM) memory.

The communication interfaces 510 can include transceivers, modems, interfaces, antennas, telephone connections, and/or other components that can transmit and/or receive data over networks, telephone lines, or other connections.

The display 512 can be a liquid crystal display or any other type of display commonly used in computing devices. For example, a display 512 may be a touch-sensitive display screen, and can then also act as an input device or keypad, such as for providing a soft-key keyboard, navigation buttons, or any other type of input.

The output devices 514 can include any sort of output devices known in the art, such as a display 512, speakers, a vibrating mechanism, and/or a tactile feedback mechanism. Output devices 514 can also include ports for one or more peripheral devices, such as headphones, peripheral speakers, and/or a peripheral display.

The input devices 516 can include any sort of input devices known in the art. For example, input devices 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 520 can store one or more sets of instructions, such as software or firmware, that embodies any one or more of the methodologies or functions described herein. The instructions can also reside, completely or at least partially, within the memory 504, processor(s) 508, and/or communication interface(s) 510 during execution thereof by the computing device 502. The memory 504 and the processor(s) 508 also can constitute machine readable media 520.

Overall, by storing data associated with previous sales attempts in sales attempt objects associated with a sales opportunity object, the CRM platform 102 can store and retain historical data associated with distinct sales attempts within the life cycle of an overall sales opportunity. Accordingly, the CRM platform 102 can use the sales attempt objects to avoid loss of data associated with previous sales attempts, when later sales attempts occur that are associated with the same sales opportunity. The data about previous sales attempts, stored in the sales attempt objects, can also be available to users of the CRM platform 102, such that the users do not have to re-enter the data about the previous sales attempts. This can reduce overall usage of memory, processor cycles, and/or other computer resources associated with the CRM platform 102. Similarly, because data about previous sales attempts can be stored in the sales attempt objects, the CRM platform 102 can avoid creating multiple sales opportunity objects in memory that are associated with different sales attempts of the same overall sales opportunity, and thereby reduce duplication of data overall. This reduction in data duplication can also reduce overall usage of memory, processor cycles, and/or other computer resources associated with the CRM platform 102.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
generating, by one or more processors, and in memory associated with a customer relationship management (CRM) platform, a sales opportunity object associated with a sales opportunity;
generating, by the one or more processors, and in the memory, a sales attempt object linked to the sales opportunity object;
storing, by the one or more processors, first sales attempt data in the sales opportunity object, wherein the first sales attempt data corresponds with a first sales attempt associated with the sales opportunity;
changing, by the one or more processors, the sales opportunity object to a dormant stage;
determining, by the one or more processors, an activation of a sales attempt trigger associated with the sales opportunity object, based on:
receipt of a request to change the sales opportunity object from the dormant stage to an active stage; and
the request being received at least a threshold period of time after the sales opportunity object was changed to the dormant stage; and
populating, by the one or more processors, and in response to the activation of the sales attempt trigger, one or more fields of the sales attempt object based on the first sales attempt data stored in the sales opportunity object.

2. The computer-implemented method of claim 1, further comprising creating, by the one or more processors and in response to a second activation of the sales attempt trigger, a second sales attempt object linked to the sales opportunity.

3. The computer-implemented method of claim 2, further comprising incrementing, by the one or more processors, a sales attempt count field of the sales opportunity object.

4. The computer-implemented method of claim 1, further comprising storing, by the one or more processors, second sales attempt data in the sales opportunity object, wherein the second sales attempt data corresponds with a second sales attempt associated with the sales opportunity.

5. The computer-implemented method of claim 1, wherein the sales attempt object is generated as a shell record, and populating the one or more fields of the sales attempt object comprises filling in one or more empty fields of the shell record.

6. The computer-implemented method of claim 1, wherein populating the one or more fields of the sales attempt object comprises performing one or more copy operations to copy one or more elements of the first sales attempt data from the sales opportunity object to the sales attempt object.

7. The computer-implemented method of claim 1, wherein populating the one or more fields of the sales attempt object comprises performing one or more move operations to move one or more elements of the first sales attempt data from the sales opportunity object to the sales attempt object and to clear the one or more elements of the first sales attempt data from the sales opportunity object.

8. The computer-implemented method of claim 1, wherein populating the one or more fields of the sales attempt object comprises deriving one or more of an active sales attempt duration or a dormancy duration based on at least one of the sales opportunity object or the sales attempt object.

9. The computer-implemented method of claim 1, wherein the dormant stage is a not now stage indicating that a customer has not expressed a current interest in the sales opportunity.

10. The computer-implemented method of claim 1, further comprising causing, by the one or more processors, a user interface associated with the CRM platform to display:
current information associated with the sales opportunity stored in the sales opportunity object; and
historical information associated with the first sales attempt stored in the sales attempt object.

11. One or more computing devices, comprising:
one or more processors; and
memory storing computer-executable instructions associated with a customer relationship management (CRM) platform that, when executed by the one or more processors, cause the one or more computing devices to perform operations comprising:
generating, in the CRM platform, a sales opportunity object associated with a sales opportunity;
generating, in the CRM platform, a sales attempt object, wherein the sales attempt object is linked to the sales opportunity object in the CRM platform;
storing first sales attempt information associated with a first sales attempt, within a life cycle of the sales opportunity, in the sales opportunity object;
changing the sales opportunity object from an active stage to a dormant stage;
changing the sales opportunity object from the dormant stage to the active stage or a second active stage, based on initiation of a second sales attempt within the life cycle of the sales opportunity;
populating the sales attempt object based on the first sales attempt information stored in the sales opportunity object; and
updating the sales opportunity object based on second sales attempt information associated with the second sales attempt.

12. The one or more computing devices of claim 11, wherein the operations further comprise:
changing the sales opportunity object from the active stage or the second active stage to the dormant stage or a second dormant stage;
changing the sales opportunity object from the dormant stage or the second dormant stage to the active stage, the second active stage, or a third active stage based on initiation of a third sales attempt within the life cycle of the sales opportunity;
creating a second sales attempt object linked to the sales opportunity, in response to changing the sales opportunity object from the dormant stage or the second dormant stage to the active stage, the second active stage, or the third active stage based on initiation of the third sales attempt;
populating the second sales attempt object based on the second sales attempt information stored in the sales opportunity object; and
updating the sales opportunity object based on third sales attempt information associated with the third sales attempt.

13. The one or more computing devices of claim 11, wherein the operations further comprise:
determining that a sales attempt trigger associated with the sales opportunity object has been activated; and
populating the sales attempt object, based on the first sales attempt information stored in the sales opportunity object, in response to determining that the sales attempt trigger has been activated.

14. The one or more computing devices of claim 13, wherein determining that the sales attempt trigger associated with the sales opportunity object has been activated comprises determining that at least a threshold period of time has passed between:
changing the sales opportunity object from the active stage to the dormant stage, and
changing the sales opportunity object from the dormant stage to the active stage or the second active stage.

15. The one or more computing devices of claim 11, wherein the dormant stage is a not now stage indicating that a customer has not expressed a current interest in the sales opportunity.

16. The one or more computing devices of claim 11, wherein the operations further comprise causing a user interface of the CRM platform to display:
current information associated with the sales opportunity stored in the sales opportunity object; and
historical information associated with the first sales attempt stored in the sales attempt object.

17. A customer relationship management (CRM) platform comprising:
memory storing a plurality of data objects comprising:
a plurality of sales opportunity objects associated with a plurality of sales opportunities; and
a plurality of sales attempt objects associated with the plurality of sales opportunity objects,
wherein individual sales opportunity objects, of the plurality of sales opportunity objects, are associated with one or more related sales attempt objects, of the plurality of sales attempt objects, and
wherein the plurality of sales attempt objects are configured to store historical information associated with distinct historical sales attempts within life cycles of the plurality of sales opportunities; and
a user interface configured to display:
current information associated with a sales opportunity, based on a sales opportunity object of the plurality of sales opportunity objects, and
historical information associated with one or more previous sales attempts, associated with the sales opportunity, based on one or more sales attempt objects of the plurality of sales attempt objects.

18. The CRM platform of claim 17, wherein the CRM platform is configured to:
detect activations of sales attempt triggers, associated with the plurality of sales opportunity objects, indicating initiations of new sales attempts, and
populate the plurality of sales attempt objects based on information associated with previous sales attempts stored in the sales opportunity objects, in response to the activations of the sales attempt triggers.

19. The CRM platform of claim 17, further comprising a downstream analysis system configured to determine dormancy periods between the distinct historical sales attempts based on the plurality of sales attempt objects.

20. The CRM platform of claim 19, wherein:
the downstream analysis system comprises a machine learning model, and
the machine learning model is trained to generate, based on the plurality of sales opportunity objects and the plurality of sales attempt objects, a prediction of a dormancy duration between sales attempts that is most likely to lead to a completed sale.
